(19) United States
(12) Patent Application Publication
(10) Pub. No.: US 2017/0228999 A1
(43) Pub. Date: Aug. 10, 2017

(54) INTEGRATED WATER DETECTION SENSOR

(71) Applicant: Haws Corporation, Sparks, NV (US)

(72) Inventors: Michael Joyer, Reno, NV (US); Daniel Small, Reno, NV (US)

(21) Appl. No.: 15/425,860

(22) Filed: Feb. 6, 2017

Related U.S. Application Data
(60) Provisional application No. 62/291,435, filed on Feb. 4, 2016.

(51) Int. Cl. G08B 21/18; A61H 35/02; A47K 3/28

(52) U.S. Cl. CPC G08B 21/18; A47K 3/286; A61H 35/02

(57) ABSTRACT

The water detection sensor includes a retrofit system such as a water-proof housing that selectively attaches to an exterior of a water conduit coupled at or near a dispense outlet of an emergency safety shower or emergency eyewash unit. The sensor may include a pair of guidewires that extend through the body of the water conduit and have a pair of respective electrodes that reside therein in non-conductive relation during an “off” or “no flow” condition. In an “on” or “flow” condition, the electrodes become immersed in water and can conduct electricity therebetween by way of the electrically conductive water medium. As such, a water conductivity circuit coupled thereto and disposed within the water-proof housing may relay a signal to a controller, which activates an audible or visual alarm that water is flowing through the emergency safety shower and/or the emergency eyewash unit.

### BACKGROUND OF THE INVENTION

The present invention generally relates to water detection and alarm activation in safety showers, eyewash units, and the like. More specifically, the present invention relates to a water detection sensor integrated into an emergency safety shower head and/or an emergency eyewash unit, for detecting the presence of water therein and, thereafter, activating an alarm when water is present.

Water flow detection systems and related alarm activation systems that activate in the presence of water flow are generally known in the art. In particular, water flow detection systems and related alarm activation systems are also well known in the art of emergency safety showers and emergency eyewash units. Although, water flow activation is typically detected by some sort of flow switch (e.g., a mechanical, thermal, magnetic, or pressure-differential) placed in the water supply pipe, and before the water reaches the emergency safety shower dispense outlet or the eyewash unit. When the emergency safety shower and/or the emergency eyewash unit are off, water in the supply pipe is stationary or otherwise cut-off (i.e., a “no flow” condition). When the emergency safety shower and/or the emergency eyewash unit are activated, water in the supply pipe starts to move. Known sensors detect movement of water through the supply pipe, and before the water reaches the emergency safety shower dispense outlet or emergency eyewash unit. Sensed water flowing through the supply pipe may cause activation of an audible or visual alarm, thereby notifying those nearby of the emergency; or at least that water is flowing through the supply pipe.

Another known water flow detection system utilizes a proximity switch that detects movement of a valve or joint (e.g., a ball valve), which may be used to open water flow to the emergency safety shower or the emergency eyewash unit. For example, when the handle of the ball valve is initially in the closed or “no-flow” position, the handle may position a proximity sensor a sufficient distance away from a detector so the water flow detection system identifies the current “no flow” or closed state. Although, when the handle is rotated, thereby turning the emergency safety shower or the emergency eyewash unit to an “on” or “flow” condition, the corresponding proximity sensor may also be repositioned into contact with or an identifiable distance from a reader—sensing the proximity sensor allows the system to identify an “on” or “flow” condition. Accordingly, the water flow detection system may trigger an alarm or other audio or visual notification that the emergency safety shower head and/or the emergency eyewash unit have been activated and are dispensing water.

While these systems may be adequate for water flow detection within a supply pipe, such as one that feeds an emergency safety shower or an emergency eyewash unit, such systems do have drawbacks. For instance, systems that incorporate a flow switch or proximity sensor to sense water movement within a supply pipe, or otherwise rely on detection of valve or joint movement, tend to be relatively expensive and are difficult to quickly and easily retrofit into existing emergency safety shower heads and/or emergency eyewash units. In this respect, retrofit installation oftentimes requires difficult disassembly of the emergency safety shower and/or emergency eyewash components to access the inside of the supply pipe, where the mechanical, thermal, magnetic, or pressure-differential can be positioned to detect water flow through the supply pipe. The same is true with proximity sensors, namely the valve or joint must be disassembled and a proximity sensor placed therein with enough precision and clearance such that movement of the valve or joint positions the proximity sensor close enough to a reader to trip an alarm indicating the valve or joint has been moved from an “off” or “no flow” condition to an “on” or “flow” condition. This may undesirably require modification of the operational components of the valve or joint. Installation costs can also rise in the event the supply pipe or valve or joint are not readily accessible (e.g., hidden behind a wall unit or difficult to reach and disassemble). As such, the complexity of retrofitting the supply pipe or valve or joint of the emergency safety shower or emergency eyewash unit can be time consuming, thereby undesirably increasing the cost of installation on top of the added component cost. Moreover, once the flow switch or proximity sensor has been installed, the emergency safety shower or emergency eyewash unit must be reassembled, which may require additional undesired work or repair, depending on the location and accessibility of the supply pipe and/or the valve or joint. As such, it may be cost prohibitive to retrofit existing equipment. Such water detection systems can also trigger false alarms as a result of freeze or scald protection valves—these are typically considered “nuisance alarms” since an emergency condition does not actually exist.

There exists, therefore, a significant need for an emergency safety shower head and/or eyewash unit with an integrated water detection sensor that can be easily retrofitted into existing emergency safety shower heads and/or eyewash units such as by way of integration of the water detection sensor into the dispense outlet of the emergency safety shower head and/or the emergency eyewash unit. The present invention fulfills these needs and provides further related advantages.

### SUMMARY OF THE INVENTION

In one embodiment, an integrated fluid detection sensor as disclosed herein may include a fluid conduit having a central channel for passage of fluid therethrough. The fluid conduit may be an existing fluid conduit formed as part of an emergency wash unit, such as an emergency shower or eyewash unit. Alternatively, the fluid conduit may be a separate unit that may be selectively coupled to the emergency wash unit, such as by threaded engagement. Moreover, a bore in a sidewall of the fluid conduit may provide external accessibility to the central channel. Here, a fluid sensor may extend into the central channel through the bore for placement therein by at least one guide wire. The fluid sensor is designed to identify the presence or absence of fluid within the central channel, to determine whether fluid (e.g., water) is flowing through the central channel. In this respect, fluid flow may signal that the emergency wash unit has been activated. Accordingly, a controller in communication with the fluid sensor may identify a first nonuse state when the fluid sensor identifies the absence of fluid within the central channel (i.e., a no flow state) and a second use state when the fluid sensor identifies the presence of fluid within the central channel. Here, an alarm in communication with the controller may be responsive to an activation signal generated by the controller when the fluid detection sensor identifies the second use state.

Additionally, the fluid sensor may include a pair of electrodes that extend into the central channel by a respective pair of guide wires. Here, the pair of electrodes may include an anode and a cathode that are able to conduct electricity therebetween in the presence of a fluid medium, thereby identifying that the emergency wash system is in a second use state (i.e., fluid flowing therethrough). In one aspect of this embodiment, the anode and the cathode may terminate at approximately the same height within the central channel. Alternatively or in addition to, the anode and the cathode may couple to an interior surface of the central channel in non-conductive relation in the absence of a fluid medium and in conductive relation in the presence of the fluid medium.

The fluid conduit may include an inlet and a relatively smaller outlet. As such, the inlet may have a relatively higher fluid volume capacity than the relatively smaller outlet such that the activation of the emergency wash unit may cause inflow of pressurized water that generally relatively quickly fills the central passage, thereby allowing the fluid sensor to detect fluid therein and indicate to the controller the second use state. The inlet may selectively removably couple to a feed pipe in fluid communication with a pressurized fluid source, when fluid flows therethrough in the second use state, and the outlet may selectively removably couple to a safety shower head by way of snap-fit engagement therewith. A housing may enclose the controller and at least fluidly seal to a mount in the sidewall of the fluid conduit and over or otherwise generally circumscribing relationship relative to the bore, which may be located downstream of an activation valve. In this embodiment, the at least one guide wire may be hermetically sealed within the bore and the mount may include a square mount forged as part of the fluid conduit.

In another aspect of the embodiments disclosed herein, the integrated water detection sensor may be interchangeable with an emergency shower head, an emergency eyewash dispenser, or inline within a feed pipe. The controller may be positioned locally within the housing or remotely and in wireless communication with the fluid sensor. In this respect, the controller may be in hardwire or wireless communication with the fluid sensor. Moreover, the alarm may include an audible alarm or a visual alarm.

In another aspect of these embodiments, the fluid sensor may include a mechanical switch (e.g., a flow sensor), a magnetic flow switch, a thermal flow switch, or the combination of an optical transmitter and an optical receiver disposed within the central channel. More specifically, the optical transmitter may be located on one side of the central conduit and generally in alignment with the optical receiver on an opposite side thereof. Here, the presence of fluid in the central channel may interrupt conveyance of a beam from the optical transmitter to the optical receiver thereby allowing the sensor to identify the presence of fluid such that the emergency wash system is in the second use state.

In another embodiment as disclosed herein, an integrated fluid detection sensor retrofit system for an emergency wash system may include a housing having a size and shape hermetically sealable to a fluid conduit, a controller associated within the housing, and a fluid sensor at least partially enclosed within the housing and in communication with the controller. The fluid sensor may be extendable from the housing into a central channel of the fluid conduit for identifying the absence of fluid therein when the emergency wash system is in a first nonuse state and detecting the presence of fluid therein when the emergency wash system is in a second use state. Accordingly, an alarm may be associated with the controller and responsive to an activation signal generated by the controller when the emergency wash system is in the second use state.

In these embodiments, the emergency wash system may include an emergency shower or an emergency eyewash unit and the integrated fluid detection sensor retrofit system may be installable to the emergency wash system without disassembly. The fluid sensor may include an anode and a cathode extending into the central channel by a respective pair of guide wires. Here, the anode and the cathode may conduct electricity therebetween in the presence of fluid. Additionally, the housing may enclose the controller, the alarm, and at least partially enclose the fluid sensor. Here, each of the alarm and the fluid sensor may be in hardwired or wireless communication with the controller for relaying sensing information and/or activating/deactivating the alarm, depending whether the sensor detects fluid within the central channel. The housing may be of a size and shape for selectively removably coupling to a mount forged as part of the fluid conduit and generally circumscribing a bore therein located downstream of an activation valve in the emergency wash system.

In another aspect of these embodiments, the alarm may include an audible alarm or a visual alarm and the fluid sensor may include at least one guide wire hermetically sealed within the bore. More specifically, the fluid sensor may include a flow sensor, a magnetic flow switch, a thermal flow switch, or the combination of an optical transmitter and an optical receiver disposed within the central channel. In this embodiment, the optical transmitter may be located on one side of the central conduit and generally in alignment with the optical receiver on an opposite side thereof, whereby the presence of fluid in the central channel interrupts conveyance of a beam from the optical transmitter to the optical receiver thereby identifying the presence of fluid in the second use state.

In another embodiment as disclosed herein, an integrated fluid detection sensor interchangeable with an emergency shower head or an emergency eyewash dispenser may include a fluid conduit having an inlet and an outlet with a central channel therebetween for passage of fluid therethrough. Here, the inlet may have a relatively higher fluid volume capacity than the relatively smaller outlet to help ensure that the fluid conduit fills with pressurized fluid during use. A hermetically sealable bore in a sidewall of the fluid conduit may provide external accessibility to the central channel, such as to allow a fluid sensor to extend into the central channel through the bore for placement therein. The fluid sensor may include probes for identifying the presence or absence of fluid, to determine if the emergency shower head or the emergency eyewash are in an activated state. In this respect, a controller in hardwire or wireless communication with the fluid sensor may identify a first nonuse state when the fluid sensor identifies the absence of fluid within the central channel and may identify a second use state when the fluid sensor detects the presence of fluid within the central channel. Accordingly, an alarm in communication with the controller may be responsive to an activation signal generated by the controller when the fluid detection sensor identifies the second use state. A housing may enclose the controller and at least fluidly seal to a mount in the sidewall of the fluid conduit and generally circumscribe the bore.

In another aspect of this embodiment, the fluid sensor may include a pair of electrodes extending into the central channel by a respective pair of guide wires. Here, the pair of electrodes may include an anode and a cathode that couple to an interior surface of the central channel in non-conductive relation in the absence of a fluid medium and couple in conductive relation in the presence of the fluid medium. The anode and the cathode may terminate within the central channel at approximately the same height.

Additionally, the inlet may selectively removably couple to a feed pipe in fluid communication with a pressurized mains water supply when in the second use state and the outlet may selectively removably couple to a safety shower head by way of snap-fit engagement therewith. In one embodiment, the bore may be located downstream of an activation valve coupled to the pressurized mains water supply. The aforementioned mount may include a square mount forged as part of the fluid conduit. The fluid sensor may alternatively include a mechanical switch, a magnetic flow switch, a thermal flow switch, or the combination of an optical transmitter and an optical receiver disposed within the central channel. The controller may also be positioned locally within the housing or remotely and in wireless communication with the fluid sensor. In one embodiment, the optical transmitter may be located on one side of the central conduit and generally in alignment with the optical receiver on an opposite side thereof. The presence of fluid in the central channel may interrupt conveyance of a beam from the optical transmitter to the optical receiver, thereby identifying the presence of fluid in the second use state.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an perspective view of a water dispense outlet incorporating a water detection sensor as disclosed herein;

FIG. 2 is a perspective view similar to FIG. 1, further illustrating the water detection sensor coupled with the dispense outlet;

FIG. 3 is a perspective cut-away view of the water detection sensor assembled to the dispense outlet taken about the line 3-3 in FIG. 2, further illustrating a pair of internally disposed nodes;

FIG. 4 is a cross-sectional view similar to FIG. 3, further illustrating the internally disposed nodes within water;

FIG. 5 is a partially exploded perspective view of the water detection sensor offset from the dispense outlet, further illustrating passthrough engagement of the internal wires between a water-proof housing of the water detection sensor and the dispense outlet;

FIG. 6 is a perspective view of an emergency eyewash unit incorporating the water detection sensor as disclosed herein;

FIG. 7 is a perspective cut-away view of the water detection sensor assembled to the emergency eyewash unit taken about the line 7-7 in FIG. 6, further illustrating a pair of internally disposed nodes;

FIG. 8 is a cross-sectional view similar to FIG. 7, further illustrating the internally disposed nodes within water; and

FIG. 9 is a perspective view of a combined emergency shower and emergency eyewash unit incorporating the water detection sensor disclosed herein as part of an alarm system.

### DETAILED DESCRIPTION OF THE PREFERRED EMBODIMENTS

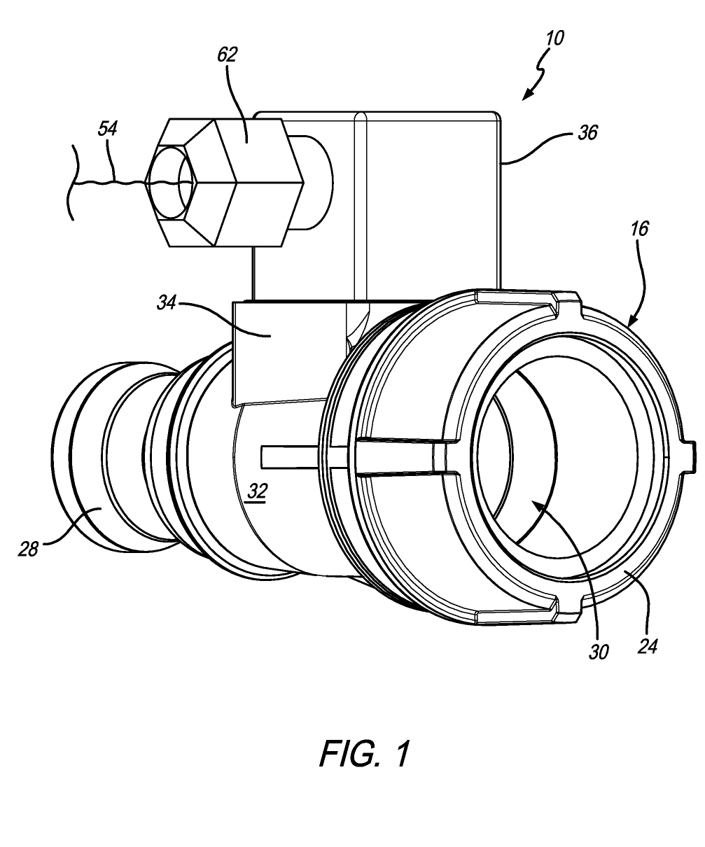

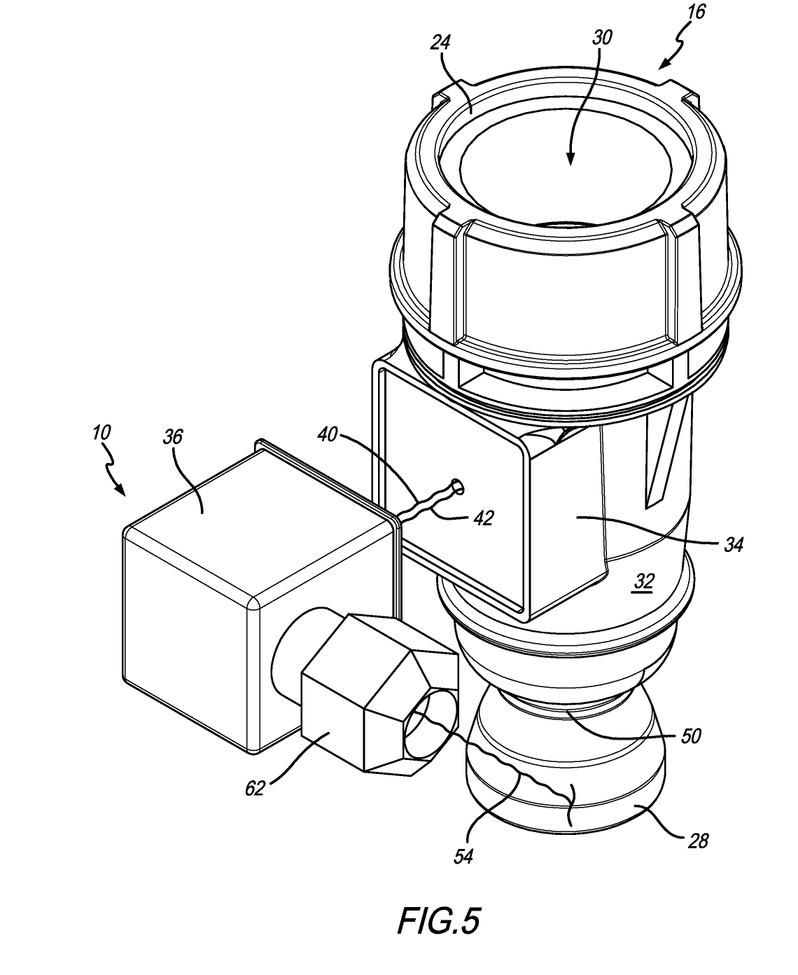

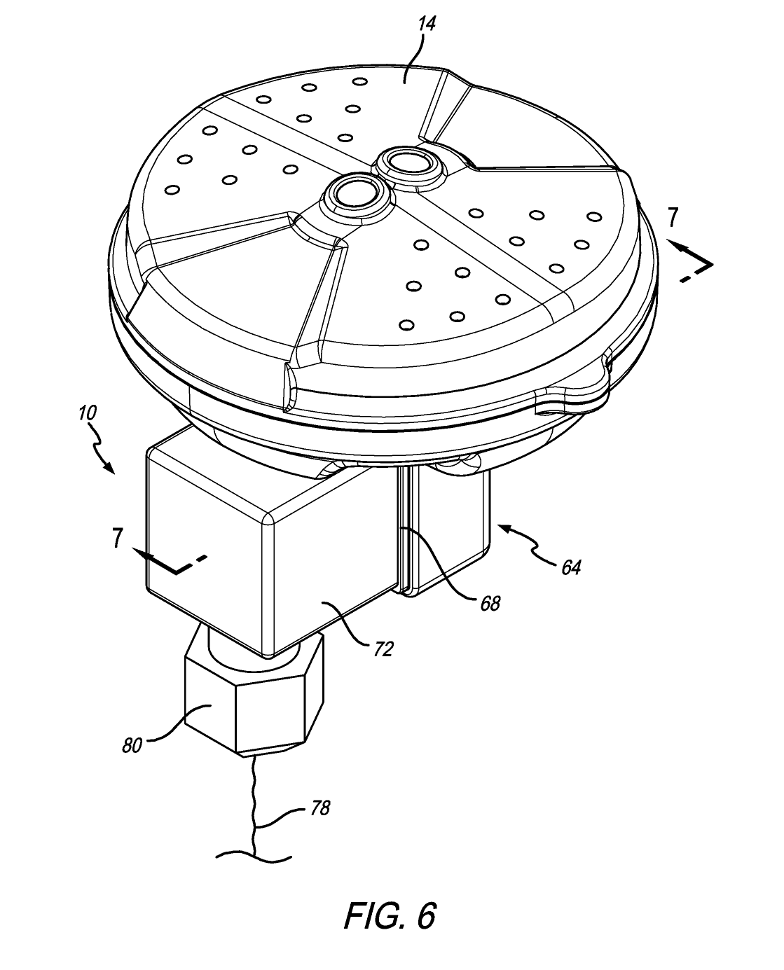

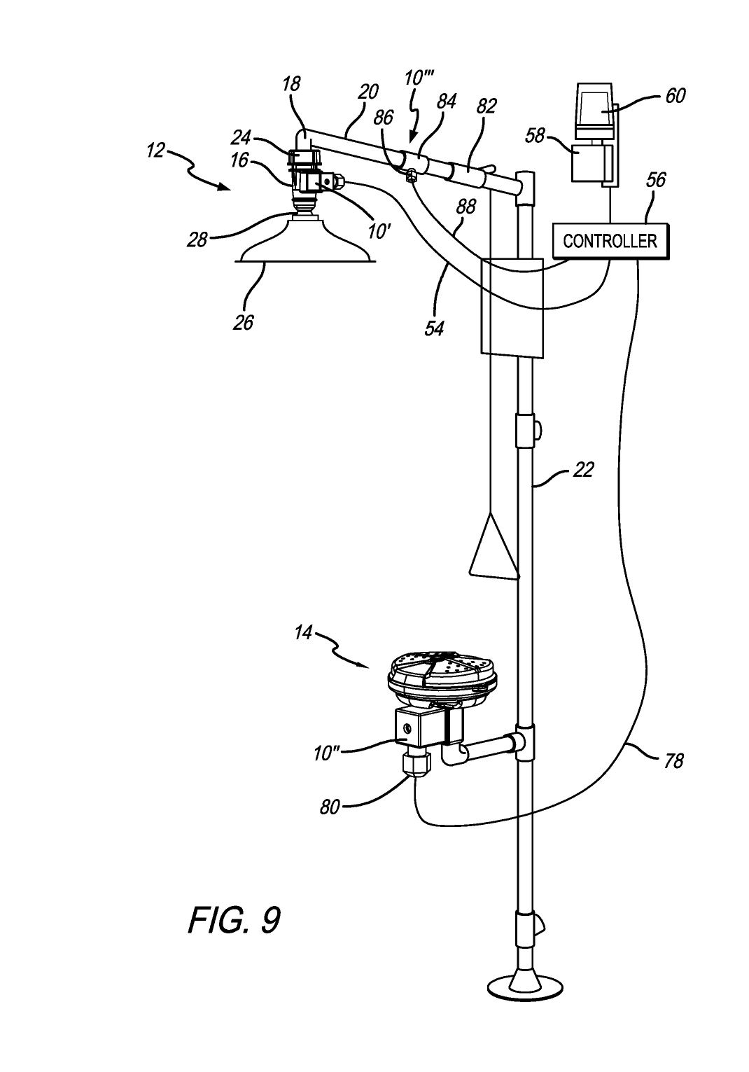

As shown in the exemplary drawings for purposes of illustration, one embodiment for a water detection sensor as disclosed herein is generally referred to by reference numeral 10 in FIG. 1. The water detection sensor 10 as disclosed herein solves problems known in the art by integrating the water detection sensor 10 directly into, e.g., an emergency safety shower head 12 (FIG. 9) and/or an emergency eyewash unit 14 (FIGS. 6-9). In one embodiment, as shown in FIGS. 1-5, the water detection sensor 10 can be easily integrated into an emergency safety shower head 12 through use of a modified dispense outlet 16. As best shown in FIG. 9, the dispense outlet 16 may be one that can be interchanged with an existing commercial emergency safety shower head 12. In FIG. 9, the dispense outlet 16 is shown attached to a downwardly projecting elbow 18 that terminates at one end of a generally horizontal feed pipe 20, which couples at an opposite end to a vertical supply pipe 22. The vertical supply pipe 22 may be coupled to a mains water supply or the like for supplying pressurized water to the emergency safety shower head 12 and/or the emergency eyewash unit 14 in the event of an emergency or during testing. The dispense outlet 16 includes a first end 24 that couples to the downwardly projecting elbow 18 (e.g., by threaded engagement) in fluid relation therewith, and to a shower head 26 (e.g., by snap-fit engagement or threaded engagement) at a second end 28 thereof. In this respect, the dispense outlet 16 provides a replacement dispense outlet with the water detection sensor 10 integrated therewith.

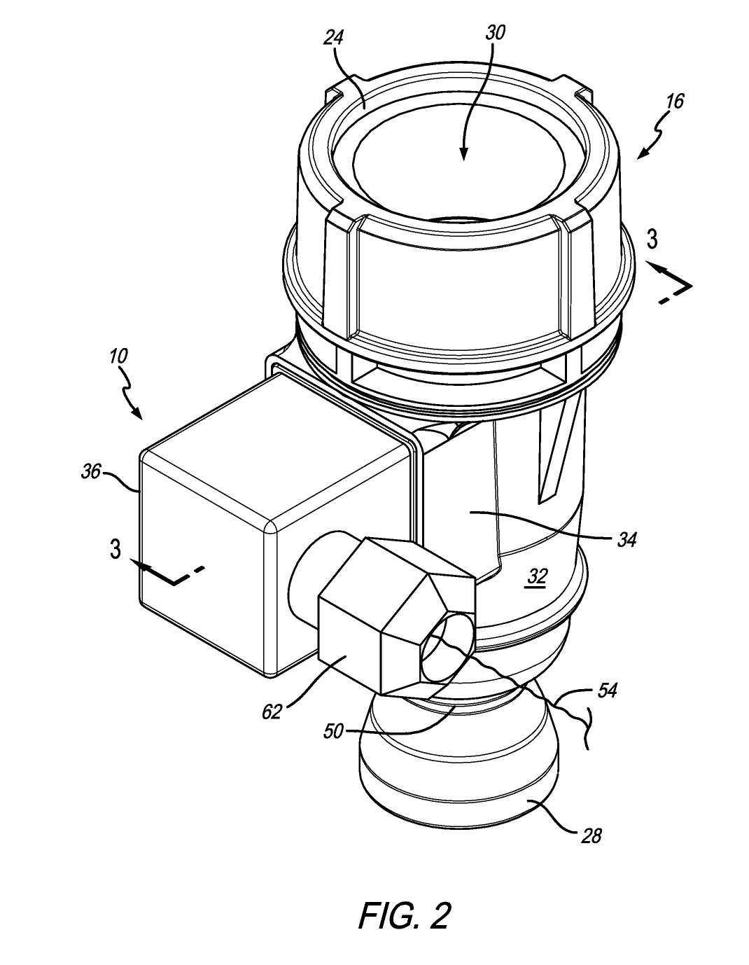

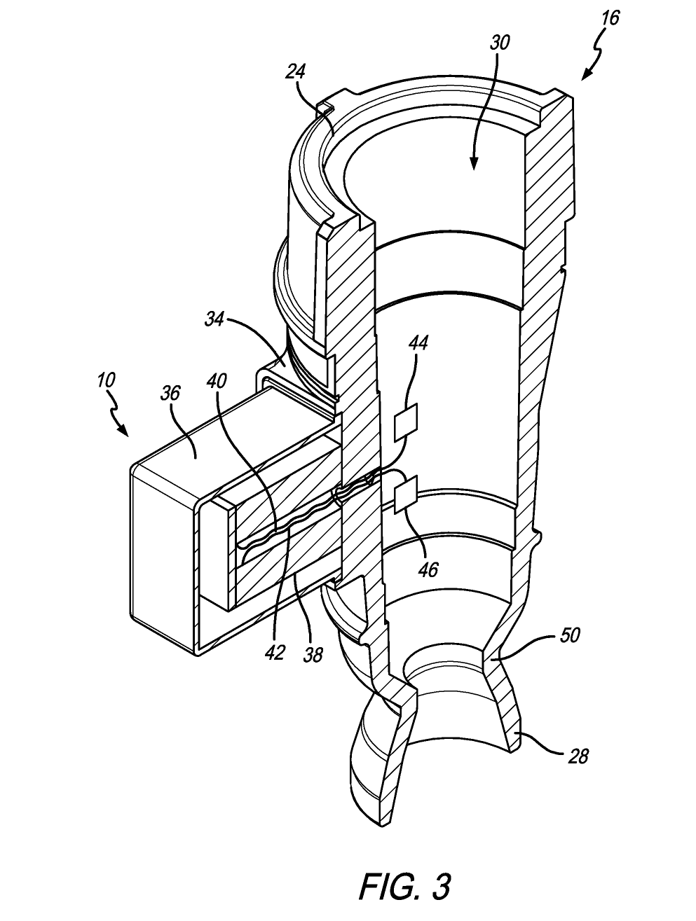

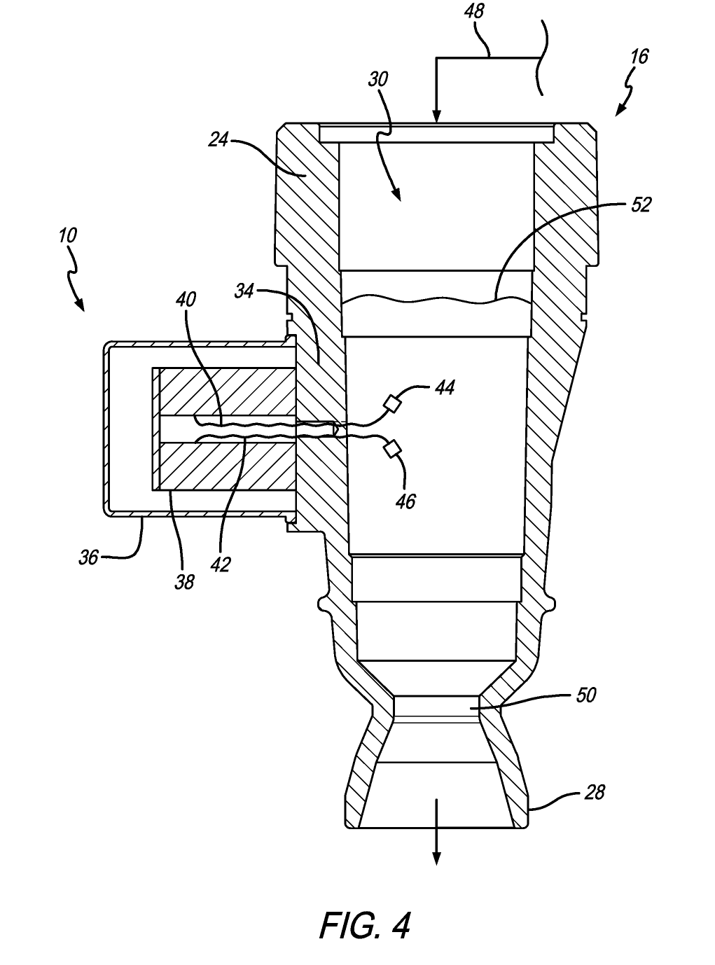

More specifically with respect to FIGS. 1-5, the modified dispense outlet 16 includes a relatively wider first end 24 that couples to the elbow 18 of the horizontal feed pipe 20 for receiving a relatively higher volume of water flow than is dispensed therefrom by the relatively narrower second end 28 at the bottom thereof. In this respect, FIGS. 3 and 4 illustrate that the dispense outlet 16 includes a central fluid conduit 30 that permits water to travel through the body of the dispense outlet 16. An outer surface 32 (FIGS. 1 and 2) of the dispense outlet 16 includes a relatively square mount 34 that may be forged as part of the body of the dispense outlet 16 and configured to selectively receive and retain a water-proof housing 36 (e.g., by snap-fit reception therein) having a water conductivity circuit 38 mounted therein (shown best in FIGS. 3-4). The water conductivity circuit 38 monitors the water presence and could be housed locally in the water-proof housing 36 or, alternatively, the water conductivity circuit 38 may be located remotely in a separate box or as part of a remote communication center. In this embodiment, a pair of guidewires 40, 42 extend from the conductivity circuit 38 and feed through the body of the water-proof housing 36, through the outer surface 32 of the dispense outlet 16 and into the interior of the central fluid conduit 30 and terminate in an anode terminal 44 and a cathode terminal 46, as shown best in FIGS. 3 and 4. The terminals 44, 46 preferably reside within the interior of the central fluid conduit 30 at approximately the same height. In one embodiment, the terminals 44, 46 may be attached in non-conductive relation in the interior of the central fluid conduit 30 to prevent movement therein.

At least initially, the central fluid conduit 30 is empty, i.e., the emergency safety shower head 12 is in an “off” or “no flow” condition, as shown in FIG. 3. Here, the central fluid conduit 30 is dry, i.e., no water resides therein and no electricity is conducted between the anode 44 and the cathode 46 due to the absence of conductive material disposed therebetween. Once the emergency safety shower head 12 is turned to an “on” or “flow” position, water enters the first end 24 of the dispense outlet 16 from the elbow 18, as generally indicated by the directional arrow 48 shown in FIG. 4. As briefly mentioned above, water enters the central fluid conduit 30 at a relatively higher volume near the first end 24 as a result of the relatively larger diameter opening. Water flows through the body of the central fluid conduit 30 and is directed downwardly into a narrowing tapered section 50 having a relatively smaller diameter than both the first end 24 and the open second end 28. In this respect, water passing through the tapered section 50 is accelerated for dispensing at a relatively higher velocity as the water passes therethrough into the outwardly opening second end 28. But, decreasing the volumetric passthrough of liquid through the central fluid conduit 30 by reducing the internal diameter therein at the tapered section 50 creates an immediate backup of pressurized water in the dispense outlet 16, thereby ensuring that the central fluid conduit 30 remains full of water when in the “on” or “flow” position. FIG. 4 illustrates, by way of example, a condition where the water within the central fluid conduit 30 rises to a level 52 above the positioning of both the anode 44 and the cathode 46. As such, the anode 44 and the cathode 46 are immersed within water in the central fluid conduit 30 and able to conduct electricity therebetween. Such a condition is relayed back to the water conductivity circuit 38 by virtue that the anode 44 and the cathode 46 are able to conduct electricity therebetween, indicating that water is inside the central fluid conduit 30. The water conductivity circuit 38 then relays a signal across a wire 54 to a controller 56 (FIG. 9), which may be designed to operate an audio alarm 58 (e.g., a siren or the like) or a visual alarm 60 (e.g., a flashing light or the like) indicating that the emergency safety shower head 12 has been activated.

Of course, the central fluid conduit 30 does not necessarily need to backfill (or be completely full), only that enough water must pass therethrough to enable an electrical connection between the anode 44 and the cathode 46 therein. The wire 54 may electrically couple to the water conductivity circuit 38 within the water-proof housing 36 by way of a junction box 62 or the like attached thereto, as shown best in FIGS. 1 and 2.

Additionally, in another aspect of this embodiment, the water-proof housing 36 may be configured for retrofit attachment to a conventional dispense outlet (not shown). In this embodiment, a relatively small wire conduit may be drilled or bored into the outer surface of the conventional dispense outlet and threaded with the guidewires 40, 42. Once threaded, the bore may be soldered shut or otherwise hermetically sealed so that the anode 44 and the cathode 46 reside within the interior of the conventional dispense outlet and electrically couple to the externally placed water conductivity circuit. This embodiment operates similar to the dispense outlet 16 described above, namely the anode 44 and the cathode 46 are able to conduct electricity therebetween thereby completing an electrical circuit when the conventional dispense outlet receives or fills with water. As such, this triggers a relay in the water conductivity circuit 38 that the conventional dispense outlet is filled with or otherwise dispensing water. Such a condition may be relayed to the aforementioned controller 56 for sounding the audio alarm 58 or activating the visual alarm 60.

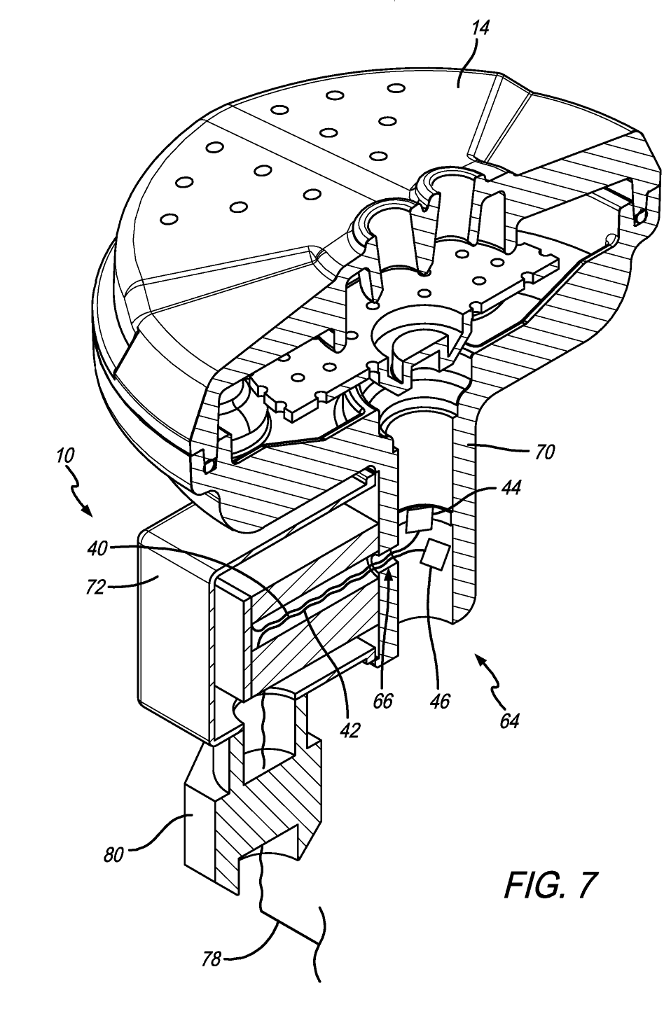

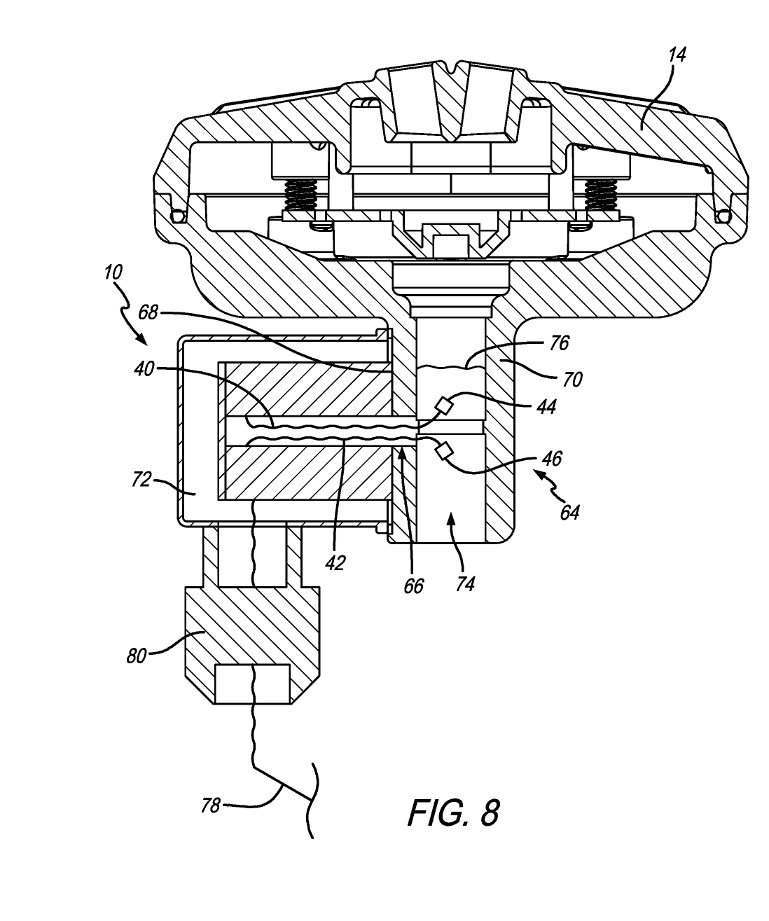

The emergency eyewash unit 14 may be retrofitted with the water detection sensor 10 in a similar manner as the emergency safety shower head 12, as shown in more detail with respect to FIGS. 6-8. For example, FIG. 6 is a perspective view of the emergency eyewash unit 14 having an integral dispense conduit 64 built into or otherwise formed or connected to the emergency eyewash unit 14. Accordingly, in this embodiment, a relatively small wire conduit 66 may be bored or drilled into a sidewall 68 of an upwardly projecting water conduit 70. The wire conduit 66 permits threading the pair of guidewires 40, 42 therethrough for placement of the respective anode 44 and the cathode 46 within the interior of the water conduit 70 as shown in FIGS. 7 and 8. The wire conduit 66 is then soldered or otherwise hermetically closed to ensure the water conduit 70 remains watertight. This may be accomplished without any disassembly of the emergency eyewash unit 14. Similarly, the anode 44 and/or the cathode 46 may be statically positioned within the interior of the water conduit 70 in non-conductive relation while the water conduit 70 is not filled with water. The water conductivity circuit 38 (not shown in FIGS. 6-8) is mounted within a housing 72 (e.g., a water-proof housing) that attaches to the water conduit 70 or surrounding structure of the emergency eyewash unit 14.

In operation, water flows up into the water conduit 70 along directional arrow 74 (FIG. 8) when the emergency eyewash unit 14 is activated. At least initially, the water conduit 70 does not contain any water, as shown in the cross-sectional view of FIG. 7. Here, the anode 44 and the cathode 46 remain electrically isolated due to a lack of a conductive substance therebetween. Once the water conduit 70 fills with or otherwise receives water flow, as indicated, e.g., with respect to a water line 76 in FIG. 8, the anode 44 and the cathode 46 become immersed in the water. The water serves as a conductive medium thereby closing the circuit between the anode 44 and the cathode 46, which generates electrical current therebetween that can be measured by the water conductivity circuit 38 in the housing 72 as coupled thereto by the guidewires 40, 42. As such, the water conductivity circuit 38 generates a signal that can be sent back to the controller 56 along a wire 78 identifying the presence of water in the water conduit 70, which indicates that the emergency eyewash unit 14 has been activated and that water is flowing to the dispense outlet. As such, the controller 56 may be configured to activate the audio alarm 58 and/or the visual alarm 60 in response thereto. The wire 78 may selectively couple to the water conductivity circuit 38 internally disposed in the housing 72 by way of a similar junction box 80.

In an alternative embodiment, the water detection sensor 10 could be provided as part of a combination emergency safety shower and emergency eyewash system, with a control box (e.g., comparable to the controller 56) to make a complete, self-contained alarm retrofit package. In this embodiment, the shower head and eyewash sensors 10′, 10″ (e.g., as shown in FIG. 9) could be hardwired to the controller 56, which may be clamped directly on to the vertical supply pipe 22, by way of the respective wires 54, 78. The controller 56 would monitor the water detection sensors and activate the audio alarm 58 (e.g., a siren) and/or the visual alarm 60 (e.g., a light) when water is present.

Of course, the water detection sensor 10 could be one of several different types, not necessarily limited to a sensor with the pair of guidewires 40, 42 that extend into the interior of the water flow path thereby sensing water therein when the water acts as an electrical conduit coupling the anode 44 with the cathode 46. For example, in one alternative embodiment, the guidewires 40, 42 may terminate in an LED transmitter and a receiver. In this embodiment, the LED transmitter may be positioned at one side, e.g., of the central fluid conduit 30 (FIGS. 1-5) and/or the water conduit 70 (FIGS. 6-8) and in alignment with a receiver positioned at an opposite side therein. When the conduit 30, 70 is empty, the receiver is able to receive or otherwise sense the light emitted by the LED. When the conduit 30, 70 fills with moving water, light emitted by the LED is reflected away from the receiver. As such, when the amount of light sensed by the receiver falls below a predetermined threshold, the water conductivity circuit 38 is able to identify an “on” or “flow” condition. In other embodiments, the water detection sensor 10 may be in the form of a mechanical switch (e.g., a flow sensor) disposed within the interior of the conduit 30, 70 that activates when water flows across. Other embodiments of the water detection sensor 10 may include a magnetic flow switch or a thermal flow switch.

Additionally, the water detection sensor 10 could be hardwired, as described above, wherein the water detection sensor 10 connects to a physical cable supplying a low-voltage power supply (not shown). In another alternative embodiment, the water detection sensor 10 may be wireless, such as including a built-in wireless transmitter powered by an internal battery or an external wired power source. In this embodiment, flow condition information (i.e., whether in the “on” or “flow” condition, or whether in the “off” or “no flow” condition) may be relayed wirelessly to the controller 56.

In an additional aspect of the embodiments disclosed herein, the water detection sensor 10 may interface directly with a safety monitoring system (e.g., communicating through a wired connection or wireless transmission), or the water detection sensor 10 may interface with a supplied control box (e.g., the controller 56) that functions as a stand-alone alarm system. The customer could also interface with the control box (i.e., the controller 56) directly.

Additionally, as shown in FIG. 9, a water detection sensor 10′″ could be integrated inline within the horizontal feed pipe 20 on a dry side of a ball valve 82, such as by way of a pipe tee 84 as shown. Here, the water detection sensor 10′″ may be embedded in a relatively small pipe plug 86 in the pipe tee 84 and include a communication relay 88 (e.g., for transmitting a hardwired or wireless communication signal) to the controller 56. In this embodiment, the anode 44 and/or the cathode 46 may project inwardly into the central channel of the horizontal feed pipe 20 and be embedded in a water-proof material such as plastic, epoxy, or the like, for detecting the presence or absence of water therein. This embodiment does not require modification of the original shower head 26 since the water detection sensor 10′″ would still be able to detect the presence or absence of water within the horizontal feed pipe 20 on the dry side of the ball valve 82 in the event of activation and water flow therethrough to the shower head 26.

The advantages of the embodiments disclosed herein are that integration of the water detection sensor 10 with the water conductivity circuit 38 is relatively inexpensive when compared to the cost of a flow switch or proximity switch in the supply pipe. The embodiments disclosed herein also place the point of detection downstream of the activation valve, thereby significantly reducing and preferably eliminating “nuisance” alarms caused by a flow switch. Additionally, the embodiments disclosed herein allow the customer to easily retrofit existing safety showers with activation sensors by simply replacing the shower head and/or eyewash. No other modifications to the emergency safety shower are required and the retrofit can be performed while the emergency shower head and emergency eyewash unit remain in service. Consequently, this eliminates the need for expensive flow switches or proximity switches, which allows the sensors to be easily retrofitted onto existing showers. The sensor probes can be molded directly into the shower head and the use of common electrical housing connectors provide water-tight protection for the electronics.

Although several embodiments have been described in detail for purposes of illustration, various modifications may be made without departing from the scope and spirit of the invention. Accordingly, the invention is not to be limited, except as by the appended claims.

What is claimed is:

1. An integrated fluid detection sensor, comprising:
a fluid conduit having a central channel for passage of fluid therethrough;
a bore in a sidewall of the fluid conduit providing external accessibility to the central channel;
a fluid sensor extending into the central channel through the bore for placement therein by at least one guide wire and for identifying the presence or absence of fluid within the central channel;
a controller in communication with the fluid sensor for identifying a first nonuse state when the fluid sensor identifies the absence of fluid within the central channel and a second use state when the fluid sensor identifies the presence of fluid within the central channel; and
an alarm in communication with the controller and responsive to an activation signal generated by the controller when the fluid detection sensor identifies the second use state.

2. The integrated fluid detection sensor of claim 1, wherein the fluid sensor comprises a pair of electrodes extending into the central channel by the guide wire comprising a respective pair of guide wires.

3. The integrated fluid detection sensor of claim 2, wherein the pair of electrodes comprises an anode and a cathode for conducting electricity therebetween in the presence of a fluid medium when in the second use state.

4. The integrated fluid detection sensor of claim 3, wherein the anode and the cathode terminate at approximately the same height within the central channel.

5. The integrated fluid detection sensor of claim 3, wherein the anode and the cathode couple to an interior surface of the central channel in non-conductive relation in the absence of a fluid medium.

6. The integrated fluid detection sensor of claim 1, wherein the fluid conduit includes an inlet and a relatively smaller outlet, the inlet having a relatively higher fluid volume capacity than the relatively smaller outlet.

7. The integrated fluid detection sensor of claim 6, wherein the inlet selectively removably couples to a feed pipe in fluid communication with a pressurized fluid source when in the second use state and the outlet selectively removably couples to a safety shower head by way of snap-fit engagement therewith.

8. The integrated fluid detection sensor of claim 1, including a housing enclosing the controller and at least fluidly sealing to a mount in the sidewall of the fluid conduit and over the bore.

9. The integrated fluid detection sensor of claim 8, wherein the mount comprises a square mount forged as part of the fluid conduit.

10. The integrated fluid detection sensor of claim 1, wherein the integrated water detection sensor is interchangeable with an emergency shower head, an emergency eyewash dispenser, or inline within a feed pipe.

11. The integrated fluid detection sensor of claim 1, wherein the bore is located downstream of an activation valve.

12. The integrated fluid detection sensor of claim 1, wherein the controller is positioned locally within the housing or remotely and in wireless communication with the fluid sensor.

13. The integrated fluid detection sensor of claim 1, wherein the controller is in hardwire or wireless communication with the fluid sensor.

14. The integrated fluid detection sensor of claim 1, wherein the alarm comprises an audible alarm or a visual alarm.

15. The integrated fluid detection sensor of claim 1, wherein the at least one guide wire is hermetically sealed within the bore.

16. The integrated fluid detection sensor of claim 1, wherein the fluid sensor comprises a mechanical switch, a magnetic flow switch, a thermal flow switch, or the combination of an optical transmitter and an optical receiver disposed within the central channel.

17. The integrated fluid detection sensor of claim 16, wherein the optical transmitter is located on one side of the central conduit and generally in alignment with the optical receiver on an opposite side thereof, whereby the presence of fluid in the central channel interrupts conveyance of a beam from the optical transmitter to the optical receiver thereby identifying the presence of fluid in the second use state.

18. The integrated fluid detection sensor of claim 16, wherein the mechanical switch comprises a flow sensor.

19. An integrated fluid detection sensor retrofit system for an emergency wash system, comprising:
a housing have a size and shape hermetically sealable to a fluid conduit;
a controller associated within the housing;
a fluid sensor at least partially enclosed within the housing and in communication with the controller, the fluid sensor extendable from the housing into a central channel of the fluid conduit for identifying the absence of fluid therein when the emergency wash system is in a first nonuse state and detecting the presence of fluid therein when the emergency wash system is in a second use state; and
an alarm associated with the controller and responsive to an activation signal generated by the controller when the emergency wash system is in the second use state.

20. The system of claim 19, wherein the emergency wash system comprises an emergency shower or an emergency eyewash unit.

21. The system of claim 19, wherein the integrated fluid detection sensor retrofit system is installable to the emergency wash system without disassembly of the emergency wash system.

22. The system of claim 19, wherein the fluid sensor comprises an anode and a cathode extending into the central channel by a respective pair of guide wires, the anode and the cathode conducting electricity therebetween in the presence of fluid.

23. The system of claim 19, wherein the housing encloses the controller, the alarm, and at least partially encloses the fluid sensor, each of the alarm and the fluid sensor being in hardwired or wireless communication with the controller.

24. The system of claim 19, wherein the housing has a size and shape for selectively removably coupling to a mount forged as part of the fluid conduit and generally circumscribing a bore therein located downstream of an activation valve in the emergency wash system.

25. The system of claim 24, wherein the alarm comprises an audible alarm or a visual alarm and the fluid sensor includes at least one guide wire hermetically sealed within the bore.

26. The system of claim 19, wherein the fluid sensor comprises a flow sensor, a magnetic flow switch, a thermal flow switch, or the combination of an optical transmitter and an optical receiver disposed within the central channel, wherein the optical transmitter is located on one side of the central conduit and generally in alignment with the optical receiver on an opposite side thereof, whereby the presence of fluid in the central channel interrupts conveyance of a beam from the optical transmitter to the optical receiver thereby identifying the presence of fluid in the second use state.

27. An integrated fluid detection sensor interchangeable with an emergency shower head or an emergency eyewash dispenser, comprising:
a fluid conduit having an inlet and an outlet with a central channel therebetween for passage of fluid therethrough, the inlet having a relatively higher fluid volume capacity than the relatively smaller outlet;
a bore in a sidewall of the fluid conduit providing external accessibility to the central channel;
a fluid sensor extending into the central channel through the bore for placement therein and for identifying the presence or absence of fluid;
a controller in hardwire or wireless communication with the fluid sensor for identifying a first nonuse state when the fluid sensor identifies the absence of fluid within the central channel and a second use state when the fluid sensor detects the presence of fluid within the central channel;
an alarm in communication with the controller and responsive to an activation signal generated by the controller when the fluid detection sensor identifies the second use state; and
a housing enclosing the controller and at least fluidly sealing to a mount in the sidewall of the fluid conduit and generally circumscribing the bore.

28. The integrated fluid detection sensor of claim 27, wherein the fluid sensor comprises a pair of electrodes extending into the central channel by a respective pair of guide wires and terminating therein at approximately the same height.

29. The integrated fluid detection sensor of claim 28, wherein the pair of electrodes comprises an anode and a cathode that couple to an interior surface of the central channel in non-conductive relation in the absence of a fluid medium and couple in conductive relation in the presence of the fluid medium.

30. The integrated fluid detection sensor of claim 27, wherein the inlet selectively removably couples to a feed pipe in fluid communication with a pressurized mains water supply when in the second use state and the outlet selectively removably couples to a safety shower head by way of snap-fit engagement therewith, wherein the bore is located downstream of an activation valve coupled to the pressurized mains water supply.

31. The integrated fluid detection sensor of claim 27, wherein the mount comprises a square mount forged as part of the fluid conduit and the fluid sensor comprises a mechanical switch, a magnetic flow switch, a thermal flow switch, or the combination of an optical transmitter and an optical receiver disposed within the central channel.

32. The integrated fluid detection sensor of claim 31, wherein the controller is positioned locally within the housing or remotely and in wireless communication with the fluid sensor and the optical transmitter is located on one side of the central conduit and generally in alignment with the optical receiver on an opposite side thereof, whereby the presence of fluid in the central channel interrupts conveyance of a beam from the optical transmitter to the optical receiver thereby identifying the presence of fluid in the second use state.
